(19) United States
(12) Patent Application Publication
(10) Pub. No.: US 2009/0002230 A1
(43) Pub. Date: Jan. 1, 2009

(54) PSEUDOLITE-BASED PRECISE POSITIONING SYSTEM WITH SYNCHRONISED PSEUDOLITES

(76) Inventors: Chang-Don KEE, Seoul (KR); Doo-Hee YUN, Seoul (KR)

Correspondence Address: LADAS & PARRY LLP, 224 SOUTH MICHIGAN AVENUE, SUITE 1600, CHICAGO, IL, 60604, US

(21) Appl. No.: 12/206,046

(22) Filed: Sep. 8, 2008

Related U.S. Application Data
(62) Division of application No. 10/494,193, filed on May 3, 2004.

(30) Foreign Application Priority Data
Nov. 6, 2001 (KR) 2001-68836

(51) Int. Cl. G01S 5/14

(52) U.S. Cl. 342/357.12

(57) ABSTRACT

Pseudolite-based precise positioning system with synchronised pseudolites that can compute the position of a mobile station with slave pseudolites synchronised to master pseudolite is provided. Therefore pseudolite-based precise positioning system according to present invention does not need correction information of a reference station. A pseudolite-based precise positioning system for computing the position of a mobile station without correction information of a reference station, the pseudolite-based precise positioning system includes: master pseudolite with reference clock of the positioning system; at least one slave pseudolite having digitally controlled numerical controlled oscillator means; mobile station computing the position of itself based on the clock-synchronised signal from the master pseudolite and the slave pseudolite without correction information of a reference station; and clock synchronisation loop filter means having the digitally controlled numerical controlled oscillator means synchronise the clock of the slave pseudolite to the clock of the master pseudolite by transmitting synchronisation information Uₖ of the slave pseudolite to the digitally controlled numerical controlled oscillator means, clock synchronisation loop filter means generating the synchronisation information Uₖ based on the pseudorange information and carrier phase information received from the master pseudolite and the slave pseudolite.

### TECHNICAL FIELD

The present invention relates to a precise navigation system using pseudolites; and, more particularly, to a precise navigation system using synchronized pseudolites, which can perform a positioning algorithm using precisely clock-synchronized pseudolites.

### BACKGROUND ART

Researches on satellite positioning systems have started as the U.S. Department of Defense partially discloses a signal of the Global Positioning System (GPS) to civilian areas. Now, the technology has passed the level of research and development and reached the level of using it commercially. Automobile navigation systems or navigation systems of airplanes and vessels are the examples. One big advantage of the satellite navigation system is that one can find the position of himself relatively precisely with just a GPS receiver wherever he is on the globe.

However, the conventional GPS can be used in the outdoors only. It cannot be used in the inside of a building or a region where satellite signals are shut off, because the GPS can perform positioning only in a region where the GPS satellite signals are received, that is, where the GPS satellite can be observed from the antenna of the GPS receiver.

Since the radio wave transmitted from the GPS satellite is weak, if the GPS satellite is not observed and the radio wave cannot be received due to the configuration of the ground or natural features of the earth and, thus, GPS positioning could not be performed. Generally, GPS positioning can be used only in the outdoors where the GPS can be observed, and not used in the indoors, such as the inside of a building or factory.

According to the navigation system using pseudolites, which is disclosed in the present invention to solve the problems of GPS, although a moving object is inside a room, it can be positioned by receiving a pseudo satellite signal, which is the same signal as received from the GPS satellite, from a pseudolite through a GPS receiver.

The pseudolite can be used both indoors and outdoors without restrictions that the GPS or Global Navigation Satellite System (GNSS) has. Thus, it can be used for an indoor navigation system as well. Also, when it is used in the outdoors, it builds a navigation system that can be operated independently from the existing GPS or GNSS satellite.

FIG. 1 is a structural diagram illustrating a conventional precise navigation system using pseudolites. As shown in the drawing, the precise navigation system 100 using pseudolites includes pseudolites 101a to 101d, a reference station 103, and a mobile station 105. The pseudolites 101a to 101d, which are devices for generating the same signal as the GPS satellite signal, are constituent for assisting GPS or for transmitting the same signal as the GPS satellite in a region where the signal from the GPS satellite cannot be received.

The structure of pseudolites 101a to 101d is illustrated in FIG. 2. As depicted in FIG. 2, the pseudolites 101a to 101d modulate a C/A code and a navigation message, that is, pseudo random number (PRN) code and data message over a carrier wave of L1 (1575.42 MHz), and transmit the carrier wave signal to the reference station 103 and the mobile station 105. In short, the pseudolites 101a to 101d perform the role of another GPS satellite by generating the same signal as the GPS satellite.

In a precise navigation system 100 using the pseudolites illustrated in FIG. 1, the coordinates of a region where the pseudolites 101a to 101d are installed are computed by performing precise pre-surveying.

The reference station 103 transmits carrier wave correction information to the mobile station 105 by using the carrier wave satellite information transmitted from the pseudolites 101a to 101d. Then, the mobile station 105 figures out its own position by using the carrier wave information transmitted from the pseudolites 101a to 101d and the carrier wave correction information transmitted from the reference station 103. Here, the carrier wave correction information is generated by using double differenced carrier-phase information.

The mobile station 105 does not need any separate receiver. It can estimate its own position by receiving radio waves from the pseudolites 101a to 101d with the conventional GPS receiver. The precise navigation system 100 using the pseudolites 101a to 101d can be effectively used for tracking the position of a person inside a building or the position of a mobile robot operated inside a factory. Also, it can measure the position of a mobile station which moves from inside a room to the outside, successively.

FIG. 3 is a structural block diagram illustrating a mobile station of FIG. 1. In the drawing, it includes a pseudolite antenna 301, a pseudolite signal reception unit 303, a signal processing unit 305, a microprocessor 306, and a memory module software 307.

The pseudolite signal reception unit 303 processing a GPS L1 frequency of 1575.42 MHz receives a pseudolite signal through the pseudolite antenna 301 and transmits it to the signal processing unit 305. The received pseudolite signal is processed through an accumulator (not shown) and a correlator of the signal processing unit 305. The signal processing unit 305 receives the pseudolite signal from the pseudolite signal reception unit 303, decodes a navigation message by processing the pseudolite signal, determines the coordinates of the pseudolites 101a to 101d and transmits them to the microprocessor 307. The microprocessor 307 controls the operation of the signal processing unit 305 and runs the software 309 in the memory module. The microprocessor 307 and the memory module software 309 compute the propagation transmit time and pseudorange between the pseudolites 101a to 101d and the mobile station 105, and measure the position of a mobile station 105 by using the pseudolite and the pseudorange.

The conventional pseudolite navigation system determines the position of a mobile station by using a pseudolite which is not clock-synchronized. It also requires a reference station that measures the clock difference information between all pseudolites, i.e., pseudorange and carrier wave phase correction information, in order to remove error by computing the pseudorange caused by the temporal asynchronization between the pseudolites and the pseudolite clock error correction information included in the carrier-phase. Moreover, there are problems that a data link should be set up between the reference station and the mobile station to transmit the correction information to a mobile station, and that an additional algorithm should be prepared for the sampling clock-synchronization of the mobile station and the reference station due to the data link setup.

A carrier-phase (P1R) measurement (φ_{P1R}) and Doppler measurement (\dot{φ}_{P1R}) of a first pseudolite 101a, which are measured in the reference station 103 of the conventional pseudolite navigation system 100, shown in FIG. 1, are rewritten as Equation 1,

φ_{P1R}=d_{P1R}+B_{R}−b_{P1}+N_{P1R}·λ+ε_{φ}

\dot{φ}_{P1R}=\dot{B}_{R}−\dot{b}_{P1}ε_{\dot{φ}} Eq. 1

wherein d_{P1R} denotes the distance between the signal transmit antenna of the first pseudolite 101a and the receiver antenna of the reference station 103;

B_{R} denotes a clock bias of a receiver of the reference station 103;

b_{P1} denotes a clock bios of the first pseudolite 101a;

λ denotes a wavelength

$$( \frac{2997924458}{1.57542 * {10}^{9}} m )$$

of carrier wave;

N_{P1R} denotes an unknown integer for a carrier-phase between the first pseudolite 101a and the mobile station 105;

ε_{φ} denotes carrier-phase measurement noise;

\dot{B}_{R} denotes a receiver clock drift of the reference station 103;

\dot{b}_{P1} denotes a clock drift of the first pseudolite 101a; and

ε_{\dot{φ}} denotes a Doppler measurement noise.

A carrier-phase (P2R) measurement (φ_{P2R}) and a Doppler measurement (\dot{φ}_{P2R}) of a slave pseudolite 101b, which are measured in the reference station 103, are rewritten as Equation 2,

φ_{P2R}=d_{P2R}+B_{R}−b_{P2}+N_{P2R}·λ+ε_{φ}

\dot{φ}_{P2R}=\dot{B}_{R}−\dot{b}_{P2}ε_{\dot{φ}} Eq. 2

wherein d_{P2R} denotes the distance between the signal transmit antenna of the second pseudolite 101b and the receiver antenna of the reference station 103;

B_{R} denotes a clock bias of a receiver of the reference station 103,

b_{P2} denotes a clock bias of the second pseudolite 101b;

λ denotes a wavelength

$$( \frac{2997924458}{1.57542 * {10}^{9}} m )$$

of carrier wave;

N_{P2R} denotes an unknown integer for a carrier-phase between the second pseudolite 101b and the mobile station 105;

ε_{φ} denotes carrier-phase measurement noise;

\dot{B}_{R} denotes a receiver clock drift of the reference station 103;

\dot{b}_{P2} denotes a clock drift of the second pseudolite 101b; and

ε_{\dot{φ}} denotes a Doppler measurement noise.

The reference station 103 performs a difference operation as Equation 3 with respect to the carrier-phase value and Doppler value, which are measured as shown in Equations 1 and 2.

φ_{P1R}−φ_{P2R}=d_{P1R}−d_{P2R}−b_{P1}+b_{P2}+(N_{P1R}−N_{P2R})·λ+ε_{φ}

\dot{φ}_{P1R}−\dot{φ}_{P2R}=b_{P1}\dot{b}_{P2}+ε_{\dot{φ}} Eq. 3

In Equation 3, It is assumed that the precise position of the signal transmit antenna of each pseudolite 101a to 101d and the precise position of the receiver antenna of the reference station 103 are known. Actually, the positions of the antennas can be determined precisely by performing positioning. Therefore, d_{P1R}−d_{P2R} is not an unknown number but a becomes a constant term.

The reference station 103 can calculate the clock difference (ΔB₁₂) between the first pseudolite 101a and the second pseudolite 10b and the speed (Δ\dot{B}₁₂) of the clock difference as Equation 4, by using a property that the unknown number of carrier-phase is an integer and rounding off the carrier-phase difference of Equation 3.

$$\begin{matrix}Δ {B}_{12} ≡ - {b}_{P 1} + {b}_{P 2} \\ = {φ}_{P 1 R} - {φ}_{P 2 R} - ( {d}_{P 1 R} - {d}_{P 2 R} ) - \\ round \{ \frac{{φ}_{P 1 R} - {φ}_{P 2 R} - ( {d}_{P 1 R} - {d}_{P 2 R} )}{λ} \} \cdot λ + {ɛ}_{φ}\end{matrix} \\ \begin{matrix}Δ {\dot{ B}}_{12} ≡ {\dot{φ}}_{P 1 R} - {\dot{φ}}_{P 2 R} \\ = - {\dot{b}}_{P 1} + {\dot{b}}_{P 2} + {ɛ}_{\dot{φ}}\end{matrix} \qquad Eq . 4$$

Since a group of non-clock-synchronized pseudolites are used in the conventional technology, the clock difference (ΔB₁₂) and the speed (Δ\dot{B}₁₂) of the clock difference become to have the following properties.

ΔB₁₂≠0

Δ\dot{B}₁₂≠0

Accordingly, to compute the pseudorange caused by the temporal asynchronization between the pseudolites and the pseudolite clock error correction information included in the carrier-phase, the clock difference (ΔBᵢⱼ) and the speed (Δ\dot{B}ᵢⱼ) of the clock difference between an i_th pseudolite and a j_th pseudolite are computed for all pseudolites by using the reference station 103. Then, they should be transmitted to the mobile station 105 though a data link established between the reference station 103 and the mobile station 105. Here, a separate method should be used for the sampling clock synchronization of the receiver of the reference station 103 and the mobile station 105.

Meanwhile, the pseudorange (ρ) and carrier-phase (φ) measured in the mobile station 105 in the conventional technologies are expressed as Equations 5 and 6, respectively,

ρ_{P1U}==(R_{P1}−R_{U})·ê_{U}¹+B_{U}−b_{P1}+ε_{ρ}

ρ_{P2U}==(R_{P2}−R_{U})·ê_{U}²+B_{U}−b_{P1}+ε_{ρ}
.
.
.

ρ_{PkU}==(R_{Pk}−R_{U})·ê_{U}^{k}+B_{U}−b_{P1}+ε_{ρ} Eq. 5

wherein ρ_{PkU} denotes a pseudorange measurement of a k_th pseudolite which is measured in a receiver of the mobile station 105;

R_{Pk} denotes a three-dimensional positioning vector of a signal transmit antenna of the k_th pseudolite;

R_{U} denotes a three-dimensional positioning vector of a receiver-antenna of the mobile station 105;

ê_{U}^{k} denotes a three-dimensional unit vision line vector of the k_th pseudolite looked at from the mobile station 105;

B_{U} denotes a clock bias of the receiver of the mobile station 105;

b_{Pk} denotes a clock bias of the k_th pseudolite; and

ε_{ρ} denotes a pseudorange measurement error;

φ_{P1U}==(R_{P1}−R_{U})·ê_{U}¹+B_{U}−b_{P1}+ε_{ρ}

φ_{P2U}==(R_{P2}−R_{U})·ê_{U}²+B_{U}−b_{P1}+ε_{ρ}
.
.
.

φ_{PkU}==(R_{Pk}−R_{U})·ê_{U}^{k}+B_{U}−b_{P1}+ε_{ρ} Eq. 6

wherein φ_{PkU} denotes a carrier-phase measurement of a k_th pseudolite which is measured in a receiver of the mobile station 105;

R_{Pk} denotes a three-dimensional positioning vector of a signal transmit antenna of the k_th pseudolite;

R_{U} denotes a three-dimensional positioning vector of a receiver antenna of the mobile station 105;

ê_{U}^{k} denotes a three-dimensional unit vision line vector of the k_th pseudolite looked at from the mobile station 105;

B_{U} denotes a clock bias of the receiver of the mobile station 105;

b_{Pk} denotes a clock bias of the k th pseudolite;

λ denotes a wavelength

$$( \frac{2997924458}{1.57542 * {10}^{9}} m )$$

of carrier wave;

N_{PkU} denotes an unknown integer of carrier wave between the k_th pseudolite and the mobile station 105; and

ε_{φ} denotes a carrier-phase measurement error.

The unknown integer N_{PkU} of the carrier-phase of FIG. 6 can be calculated by using a carrier-phase unknown integer initializing method.

The pseudorange measurement error ε_{ρ} has a unit size of meter (m), and the carrier-phase measurement error ε_{φ} has a unit size of millimeter (mm). Thus, a pseudorange measurement or a carrier-phase measurement may be used in the determination of the position of the mobile station 105 based on the precision required. In other words, in case where meter(m)-based error is allowed, the mobile station 105 is positioned by using the pseudorange measurement. If centimeter(cm)-based error is allowed, the mobile station 105 is positioned by using the carrier-phase measurement.

Also, even in the process of positioning the mobile station 105 using a carrier-phase measurement, the approximate position of the mobile station 105 may be determined using the pseudorange measurement until the unknown integer N_{PkU} is determined.

The mobile station 105 applies the pseudolite clock correction information (ΔB₁ₖ≡−b_{P1}+b_{Pk}) transmitted from the reference station 103 to the pseudorange ρ (Eq. 5) measured by the mobile station 105.

When the clock correction information (ΔB₁ₖ≡−b_{P1}+b_{Pk}) is applied to Equation 5, below Equation 7 can be obtained.

$$[ \begin{matrix}{\hat{e}}_{U}^{1} & - 1 \\ {\hat{e}}_{U}^{2} & - 1 \\ ⋮ & ⋮ \\ {\hat{e}}_{U}^{k} & - 1\end{matrix} ] \cdot [ \begin{matrix}{R}_{U} \\ {B}_{U} - {b}_{P 1}\end{matrix} ] = [ \begin{matrix}{R}_{P 1} \cdot {\hat{e}}_{U}^{1} - {ρ}_{P 1 U} \\ {R}_{P 2} \cdot {\hat{e}}_{U}^{2} - {ρ}_{P 2 U} - Δ {B}_{12} \\ ⋮ \\ {R}_{Pk} \cdot {\hat{e}}_{U}^{k} - {ρ}_{PkU} - Δ {B}_{1 k}\end{matrix} ] + [ \begin{matrix}{ɛ}_{ρ} \\ {ɛ}_{ρ} \\ {ɛ}_{ρ} \\ ⋮ \\ {ɛ}_{ρ}\end{matrix} ] \\ That is , \\ H ( x ) \cdot x = Z ( x ) . \qquad Eq . 7$$

Here, x denotes the position of the mobile station, and the mobile station 105 determines its three-dimensional position by applying a non-linear least square method to Equation 7, which is obtained by applying the pseudolite clock correction information (ΔB₁ₖ≡−b_{P1}+b_{Pk}) transmitted from the reference station 103 to the pseudorange ρ (Eq. 5) measured by the mobile station 105.

Even when the carrier-phase φ (Eq. 6) is used, the mobile station 105 determines the position of its own in the same way that the position of the mobile station 105 is calculated using the pseudorange measurement, based on the pseudolite correction information (Δ\dot{B}₁ₖ≡−\dot{φ}_{P1R}+\dot{φ}_{PkR}) transmitted from the reference station 103.

However, in the conventional technologies, the pseudolite computes the position of the mobile station 105 by using another pseudolite whose clock is not precisely synchronized with other pseudolites, because it uses cheap Temperature Controlled Crystal Oscillator (TCXO), which is different from the GPS satellite. Accordingly, there is a problem that a separate reference station should be used to calculate the pseudorange caused by the temporal asynchronization between the pseudolites and the carrier-phase correction information (i.e., a clock difference (ΔBᵢⱼ) and the speed (Δ\dot{B}ᵢⱼ) of the clock difference between an i_th pseudolite and a j_th pseudolite). To transmit the clock difference information to the mobile station 105, a data link should be set up between the reference station 103 and the mobile station 105. This brings about such problems as complicated equipment of mobile station, cost increase by setting up an additional data link between the reference station and the mobile station for a reason other than the purpose of GPS signal reception, frequent breakdown and the like.

In addition, there is a problem that an additional algorithm should be prepared for the sampling clock synchronization of the mobile station and the reference station. If the clocks of the pseudolites are not synchronized, the clock of the reference station and the mobile station is not synchronized, either. Therefore, the reference station and the mobile station come to perform sampling on the signal transmitted from a pseudolite at different time, respectively. In this case, a time-tag error is generated due to the correction navigation which is performed with data which are sampled at different time. To solve the problem of time-tag error, the clocks of the reference station and mobile station are synchronized by using a navigation message frame of a master pseudolite.

### DISCLOSURE OF INVENTION

The present invention is suggested to solve the problems of the conventional technology which is caused by transmitting pseudorange and carrier-phase correction information, which is generated due to asynchronous pseudolite clock, from a separate reference station to a mobile station, and then computing the location of the mobile station using the correction information.

It is, therefore, an object of the present invention to provide a precise navigation system using synchronized pseudolites that can execute a navigation algorithm by synchronizing the clocks of other pseudolites to the clock of a master pseudolite so that a mobile station should not need correction information generated in a reference station.

The above and other objects and features of the present invention will become apparent to those skilled in the art from the following drawings, detailed description of the preferred embodiments and claims.

In accordance with one aspect of the present invention, there is provided a precise navigation system using pseudolites that can determine a position of a mobile station even without correction information transmitted from a reference station through a data link, including: a master pseudolite having a reference clock of the navigation system; at least one slave pseudolite having a digitally controlled numerical controlled oscillating unit; a mobile station which determines a position of the mobile station based on a clock synchronized signal transmitted from the master and slave pseudolites even without correction information transmitted from the reference station through the data link; and a clock synchronization loop filtering unit for generating synchronization information Uₖ of the slave pseudolite(s) based on the pseudorange and/or carrier-phase information received from the master pseudolite and the slave pseudolite(s), and transmitting the synchronization information Uₖ to the digitally controlled numerical controlled oscillating unit so that the digitally controlled numerical controlled oscillating unit could synchronize the clock(s) of the slave pseudolite(s) with the reference clock of the master pseudolite.

In accordance with the present invention, the clock synchronization control system of each pseudolite receives the master pseudolite signal and its own signal simultaneously, measures the clock difference between its own clock and the master pseudolite clock, and controls its own clock by using a pseudolite clock controller of the clock synchronization control system. After all, if the pseudolites are synchronized with the master pseudolite, it is possible for a mobile station to position itself with a precision of centimeter or meter even without correction information generated by a reference station. Thus, a precision navigation system without a data link for transmitting correction information between the reference station and the mobile station can be embodied.

That is, in accordance with the present invention, it is possible to embody a navigation system where a mobile station can calculates the position of itself without requiring any correction information by synchronizing the clocks of pseudolites precisely which transmit the same signal as a Global Positioning System (GPS).

However, since the pseudolite navigation system of the present invention determines the position of a mobile station by using clock-synchronized pseudolites, it does not need a reference station that measures the pseudorange and carrier-phase correction information, which is a clock difference information between the pseudolites and also does not need a data link between the reference station and the mobile station for transmitting the correction information to the mobile station. In addition, it does not need an additional algorithm for the sampling clock synchronization of the mobile station and the reference station due to the setup of the data link between the reference station and the mobile station.

Since the precise navigation system of the invention, which uses synchronous pseudolites, can enhance the economical efficiency and system stability by performing positioning with a precision of a few meters or a few centimeters without any data link, differently from the mobile stations of a differential GPS or carrier-phase differential GPS that requires correction information generated by an external reference station. This is because the pseudolites, which are signal transmitters, are synchronized precisely.

Further, the system of the present invention can be embodied just by modifying part of software, without a change in the receiver hardware of the mobile station, which uses a conventional GPS receiver. In particular, the system of the present invention can be cooperated in mutual assistance with GPS of the U.S. Department of Defense, GLONASS of Russia, and a GNSS system, such as a Galileo system of Europe which will be operated in future. Depending on cases, it can be built independently from the GNSS system at a moderate cost. Therefore, it is significant in the aspects of national economy and security.

### BRIEF DESCRIPTION OF DRAWINGS

The above and other objects and features of the present invention will become apparent from the following description of the preferred embodiments given in conjunction with the accompanying drawings, in which:

FIG. 1 is a structural diagram illustrating a conventional precise navigation system using pseudolites;

FIG. 2 is a block diagram showing a structure of the pseudolite of FIG. 1;

FIG. 3 is a block diagram depicting a structure of a mobile station of FIG. 1;

FIGS. 4A and 4B are block diagrams describing a structure of a precise navigation system using pseudolites in accordance with an embodiment of the present invention;

FIG. 5 is a block diagram showing a partial structure of pseudolites in accordance with an embodiment of the present invention;

FIG. 6 is a block diagram illustrating a digitally controlled numerical controlled oscillator and a clock synchronization loop filtering unit;

FIG. 7 is a conceptual diagram describing a pseudolite clock synchronization process of the navigation system in accordance with an embodiment of the present invention;

FIG. 8 is a flow chart describing the operation of the clock synchronization loop filtering unit;

FIG. 9 is a detailed flow chart illustrating a carrier-phase cycle slip process of FIG. 8;

FIG. 10 is a flow chart describing the clock synchronization process conversion order and condition of the clock synchronization loop filtering unit;

FIG. 11 is a graph illustrating a process of the clock synchronization loop filtering unit controlling a reference clock of the digitally controlled numerical controlled oscillator in the synchronous phase 2;

FIG. 12 is a graph describing the relationship between a switching boundary and a frequency change amount in the synchronous phase 3 of the clock synchronization loop filtering unit;

FIG. 13 is an exemplary schematic diagram showing a secondary frequency synchronization loop filter for frequency synchronization in the synchronous phase 5 of the clock synchronization loop filtering unit in accordance with an embodiment of the present invention;

FIG. 14 is an exemplary schematic diagram showing a tertiary phase synchronization loop filter for phase synchronization in the synchronous phase 7 of the clock synchronization loop filtering unit in accordance with an embodiment of the present invention; and

FIG. 15 is a graph illustrating an experimental output of the pseudolite navigation system in accordance with an embodiment of the present invention.

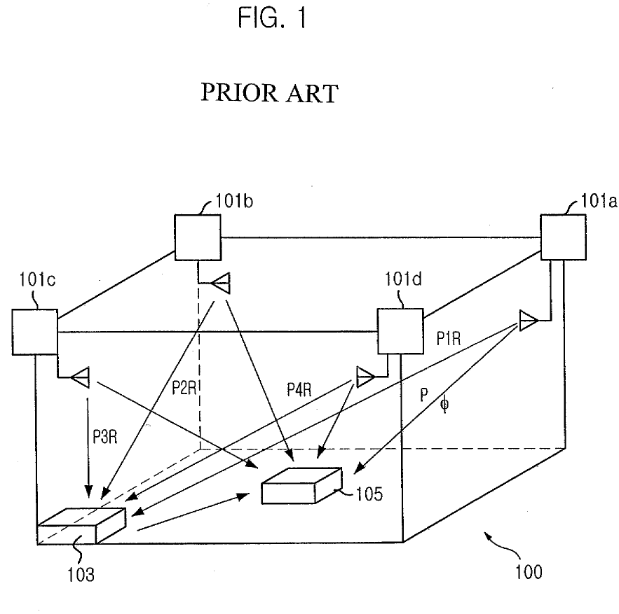

### BEST MODE FOR CARRYING OUT THE INVENTION

Following description just shows the principle of the present invention, and those skilled in the art the present invention belongs to can embody the principle of the invention and invent various devices in the range of the concept and scope of the present invention, even though they are not described or illustrated in the present specification. The conditional terminologies and embodiments mentioned in the present specification are intended to have the concept of the invention understood, and the present invention should be construed not limited to the embodiments and conditions specifically mentioned. Detailed description on the particular embodiments as well as the principle, view point and embodiments should be understood to include all other structural or functional equivalents to them. The equivalents also should be understood to include not only those currently known but also those to be developed in future, that is, all devices that are invented to perform the same function as mentioned in the specification, regardless of their structure.

For example, block diagrams of the present specification should be understood to show the conceptual viewpoint of an exemplary circuit that specifies the principle of the present invention. Similarly, all the flow charts, graphs showing a change in condition and pseudo codes can be embodied substantially in a computer-readable medium. Also, they should be understood to express processes performed by a computer or a processor, regardless of whether the computer or processor is illustrated definitely.

The functions of devices illustrated in a drawing including a functional block which is expressed as a processor or a similar concept can be provided by a dedicated hardware or a hardware which can operate a proper software for them. When the functions are provided by a processor, the processor may be a single dedicated processor, single shared processor, or a plurality of individual processors, part of which can be shared.

The use of a term ‘controller’ or other terms having similar concept should not be construed to refer to a exclusive hardware that can operate a software, but to include ROM, RAM and non-volatile memory for storing a digital signal processor (DSP), hardware and software without restriction, implicatively. Other hardware widely known and conventionally used may be included thereto. Similarly, a switch illustrated in the drawing may be one just suggested conceptually. This function of switch should be understood to be performed manually or through a program logic or dedicated program and controlled through an interaction of the program or dedicated logic. Particular technology may be selected by a designer to describe the present specification more in detail.

The constituents expressed in claims as a means for performing a function described in the detailed description part of the specification are intended to include all methods that performs the function including all forms of software, such as a combination of circuit devices performing the functions and firmware/micro code and the like. They are connected to the proper circuit for operating software to perform the functions. The system of the present invention defined as claimed is a combination of the functions provided by mentioned means and methods requested by the claims. Therefore, any means that can provide the mentioned function should be understood to be an equivalent to what is figured out from the present specification.

Other objects and aspects of the invention will become apparent from the following description with reference to the accompanying drawings, which is set forth hereinafter. The same reference number is given to the same constituent, although it appears in different drawings. Also, any detailed description that may blur the point of the present invention is omitted. Hereinafter, preferred embodiment of the present invention will be described in detail with reference to accompanying drawings.

The core technology of the present invention is a method for synchronizing the clocks of pseudolites. Clock synchronization methods are largely divided into two: One is a method using a cable and the other is a method without using a cable.

In the cable synchronization method, a clock signal of a master pseudolite is used as an input of another pseudolite through a cable. Due to the cable, this method is proper to a case where pseudolites gather in a relatively limited place. On the contrary, in the wireless synchronization method, a Global Positioning System (GPS) receiver set up in a pseudolite clock synchronization controlling system receives the signals from a master pseudolite and a pseudolite simultaneously, measures the clock difference between the master pseudolite and the corresponding pseudolite, and controls the clock of the corresponding pseudolite by using a pseudolite clock controller of the clock synchronization system.

A navigation system of the present invention using pseudolites can be used in the indoors as well as the outdoors. Accordingly, it is possible to embody an independent navigation system that can substitute for GPS and/or Global Navigation Satellite System (GNSS).

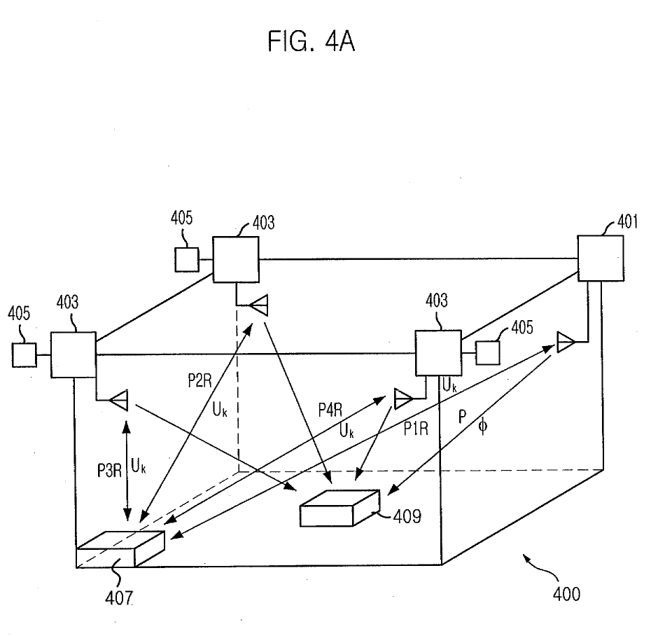

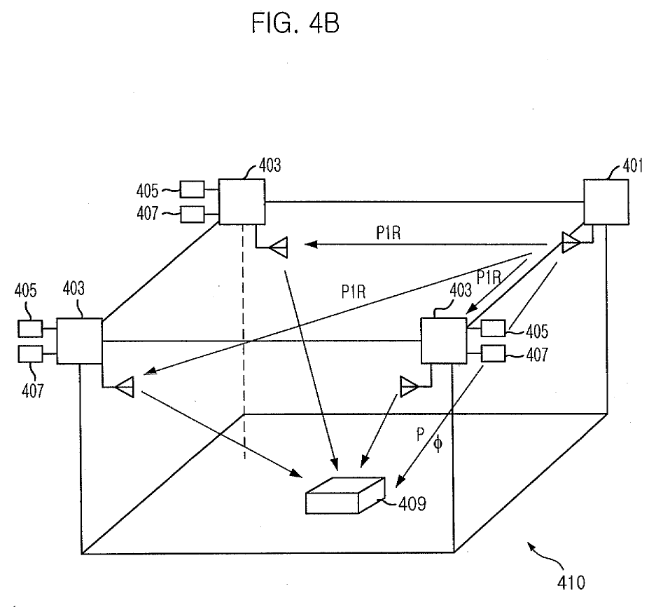

FIGS. 4A and 4B are block diagrams describing a structure of a precise navigation system using pseudolites in accordance with an embodiment of the present invention. To determine a three-dimensional position of a mobile station, at least four pseudolite signals are required. In the present specification, a navigation system that can determine a three-dimensional position is described as an embodiment of the present invention. In accordance with the embodiment of the present invention, one of pseudolites is selected as a master pseudolite, and the other pseudolites become slave pseudolites. Then, the clocks of the slave pseudolites are synchronized with the clock of the master pseudolite.

In the first embodiment illustrated in FIG. 4A, a clock synchronization loop filtering unit 407 generates a command Uₖ for synchronizing the clocks of all the slave pseudolites 403, transmits it to each of the slave pseudolites 403. Then, the slave pseudolites 403 synchronizes their clocks with a digitally controlled numerical controlled oscillator 405.

Meanwhile, in a second embodiment described in FIG. 4B, each slave pseudolite 403 has a clock synchronization loop filtering unit 407. So, it can generate a command Uₖ for synchronizing a clock to operate the digitally controlled numerical controlled oscillator 405. The slave pseudolites 403 include an antenna for transmitting a pseudolite signal and the digitally controlled numerical controlled oscillator 405 for controlling the pseudolite clock. The first embodiment includes a radio modem (not shown) for the use as a data link, which is a data interface with the clock synchronization loop filtering unit 407, in each of the slave pseudolites 403, and the second embodiment includes a GPS receiver (not shown) and an antenna are included in each of the slave pseudolites 403.

In the first and second embodiments, a pseudolite having a reference numeral 401 is taken as a master pseudolite, and the master pseudolite 401 does not include the digitally controlled numerical controlled oscillator. This is because the slave pseudolites 403 are synchronized with the clock of the master pseudolite 401 in the present invention.

A mobile station 409 includes a GPS receiver (not shown) and an antenna (not shown). The clock synchronization loop filtering unit 407 includes a GPS receiver (not shown), an antenna (not shown) and an operation unit (not shown). Particularly, in the first embodiment, the clock synchronization loop filtering unit 407 further includes a radio modem (not shown) for the use as a data link, which is a data interface with the slave pseudolites 403.

The first and second embodiments shows an example where a separate clock synchronization loop filtering unit 407 is provided as a unit for generating a clock synchronization command Uₖ and an example where the clock synchronization loop filtering unit 407 is provided to each slave pseudolite to generate a clock synchronization command Uₖ. The two embodiments have a difference just in the position and number of the clock synchronization loop filtering unit 407, but their basic concepts are not different. If only, in a case where the visibility between the pseudolites becomes a matter, the first embodiment will be suitable, and in a case where setting up a data link between the clock synchronization loop filtering unit 407 and the slave pseudolites is troublesome, the second embodiment will be able to take care of the trouble.

In the navigation system of the present invention, shown in FIGS. 4A and 4B, it is assumed that the positions of the fixed constituents are pre-determined, except for the mobile station 409. The actual positions of the fixed constituents can be determined precisely by performing positioning.

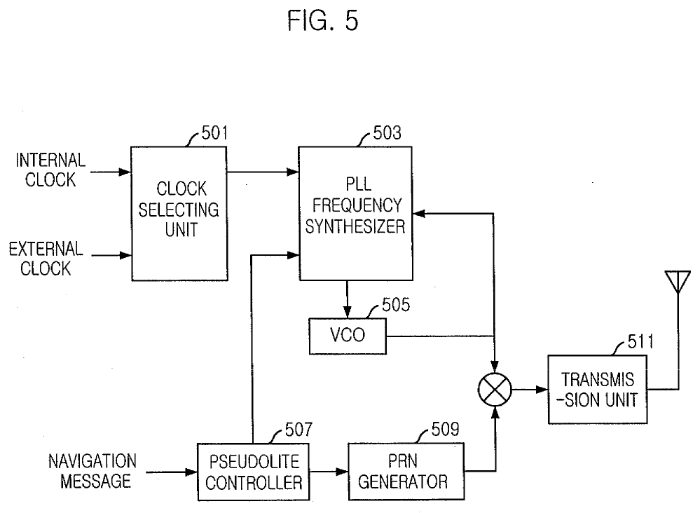

FIG. 5 is a block diagram showing a partial structure of the pseudolites 401 and 403 in accordance with an embodiment of the present invention. As illustrated in the drawing, a pseudolite can select its own clock through a clock selecting unit 501, such as a temperature controlled crystal oscillator (TCXO) or one of external clocks as a reference clock.

For example, the master pseudolite 401 uses TCXO which is its own clock installed inside as a reference clock, and the slave pseudolites 403 uses external clock as a reference clock. That is, the frequency of reference clock is 10.23 MHz and a carrier wave of 1.57542 GHz is synthesized through a PLL frequency synthesizer 503 and a voltage controlled oscillator (VCO) 505.

Here, the pseudolites 401 and 403, which are illustrated to describe the embodiment of the present invention, may have a frequency of L1 and a pseudo-random number (PRN) code rate of 1.023 MHz. However, in accordance with the present invention, the frequency of the pseudolites 401 and 403 can use a PRN code rate of 10.23 MHz as well as the frequency of L2 or L5, which are the frequency of a GPS satellite navigation system. That is, it is apparent to those skilled in the art that the pseudolite frequency and PRN code rate vary according to the navigation system using pseudolites. Therefore, the present invention should be understood not limited to a particular pseudolite frequency and PRN code rate.

Also, it is apparent to those skilled in the art that the PRN code can be a C/A code or P code according to the navigation system using pseudolites. Accordingly, the present invention should be understood not limited to a particular PRN code.

To describe the C/A code and P code more, a receiver needs to decode a unique code of each satellite to receive information from it. The C/A code, which is a kind of PRN codes, is used for standard positioning. It is also used for shortening the signal acquisition time of P code in the precise positioning system. C/A stands for Clean and Acquisition or Coarse and Acquisition, and P stands for Precision or Protect. The length of C/A code is 1023 bits, and the clock frequency is 1.023 MHz. That is, the repetition period of the C/A code is 1 ms. In the mean time, the clock frequency of P code is 10.23 MHz, which is 10 times as long as the C/A code.

A pseudolite control unit 507 initializes a PRN generation unit 509 and the PLL frequency synthesizing unit 503 suitably for the PRN number of pseudolite. The pseudolite control unit 507 receives a 50 bps navigation message from the outside through such a communication as Recommended Standard-232 Revision C (RS232C) (i.e., an interface used for serial data communication of relatively slow speed), and transmits it to the PRN generation unit 509.

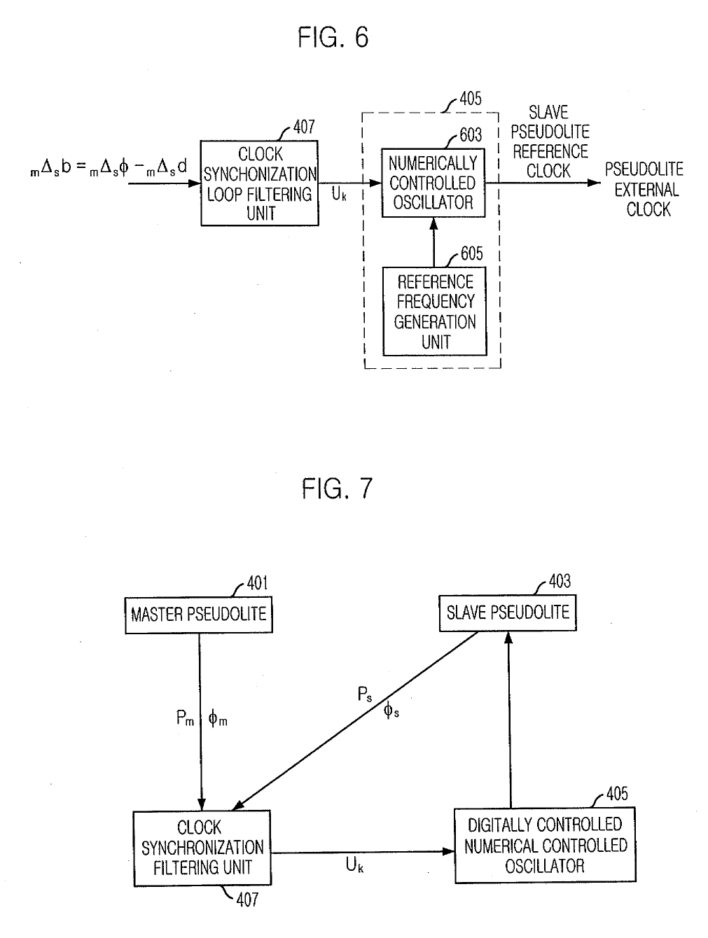

FIG. 6 is a block diagram illustrating a digitally controlled numerical controlled oscillator 405 and a clock synchronization loop filtering unit 407. If the clock difference (ΔB₁₂) of FIG. 4 and the speed (Δ\dot{B}₁₂) of the clock difference have the following characteristic, the clock of the master pseudolite 401 corresponding to the first pseudolite 101a and the clock of the slave pseudolites 403 corresponding to the second pseudolites 101b are synchronized.

ΔB₁₂=0

Δ\dot{B}₁₂=0

As shown above, to make the clock difference (ΔB₁ₖ) and the speed (Δ\dot{B}₁ₖ) of the clock difference of the master pseudolite 401 and the slave pseudolite 403 become zero, the clock of the slave pseudolite 403 should be controlled. This function of controlling the clock of slave pseudolite 403 is performed by the digitally controlled numerical controlled oscillator 405 based on the synchronization information Uₖ transmitted from the clock synchronization loop filtering unit 407.

That is, the digitally controlled numerical controlled oscillator 405 generates a reference frequency to be used as a clock source for the slave pseudolite 403 through a numerically controlled oscillator 603 based on the clock synchronization error (ₘΔₛb) between the master pseudolite 401 and the slave pseudolite 403 and the synchronization information Uₖ generated by the clock synchronization loop filtering unit 407.

The numerically controlled oscillator 603 generates a desired frequency through a relatively precise reference frequency generation unit 605, such as TCXO and oven controlled crystal oscillator (OCXO). A clock generated by the numerically controlled oscillator 603 is inputted to the slave pseudolite 403 as an external clock, and used as its reference.

The clock synchronization loop filtering unit 407 makes the clock of the slave pseudolite 403 synchronized with the clock of the master pseudolite 401 stably. That is, it controls the digitally controlled numerical controlled oscillator 405 to satisfy Equation 8 so that the clock of the slave pseudolite 403 could be synchronized with the clock of the master pseudolite 401. The clocks of the other slave pseudolites 403 are synchronized through the same process.

A mobile station 409 computes its position using the conventional method. The only difference is that when the clocks of the slave pseudolites 403 are synchronized with that of the master pseudolite 401, the pseudolite clock correction information (ΔB₁ₖ and Δ\dot{B}₁ₖ) becomes all zero, and thus Equation 7, which was used to determine the position of a mobile station 409 in the conventional technology, becomes re-written as Equation 8.

$$[ \begin{matrix}{\hat{e}}_{U}^{1} & - 1 \\ {\hat{e}}_{U}^{2} & - 1 \\ ⋮ & ⋮ \\ {\hat{e}}_{U}^{k} & - 1\end{matrix} ] \cdot [ \begin{matrix}{R}_{U} \\ {B}_{U} - {b}_{P 1}\end{matrix} ] = [ \begin{matrix}{R}_{P 1} \cdot {\hat{e}}_{U}^{1} - {ρ}_{P 1 U} \\ {R}_{P 2} \cdot {\hat{e}}_{U}^{2} - {ρ}_{P 2 U} \\ ⋮ \\ {R}_{Pk} \cdot {\hat{e}}_{U}^{k} - {ρ}_{PkU}\end{matrix} ] + [ \begin{matrix}{ɛ}_{ρ} \\ {ɛ}_{ρ} \\ {ɛ}_{ρ} \\ ⋮ \\ {ɛ}_{ρ}\end{matrix} ] \qquad Eq . 8$$

As shown in Equation 8, the mobile station 409 can determine its position independently without requiring a data link to a reference station. Therefore, the user equipment of the synchronized pseudolite navigation system becomes simplified.

As mentioned before, the pseudorange measurement error ε_{ρ} has a unit size of meter (m), and the carrier-phase measurement error ε_{φ} has a unit size of millimeter (mm). So, the pseudorange measurement error ε_{ρ} and/or carrier-phase measurement error ε_{φ} can be used for the positioning of a mobile station 409 according to the required precision. That is, in a case where meter-unit error is allowed, the mobile station 409 is positioned using the pseudorange measurement error, or if a centimeter-unit error is allowed, the mobile station 409 is positioned using the carrier-phase measurement error.

In addition, it is possible to use the pseudorange measurement error and determine an approximate position of the mobile station 409 until an unknown integer N_{PkU} is determined in the process of determining the position of the mobile station 409 using the carrier-phase measurement error.

Hereinafter, clock synchronization of the pseudolites will be described. FIG. 7 is a conceptual diagram describing a pseudolite clock synchronization process of the navigation system in accordance with an embodiment of the present invention. In the drawing, ρ denotes a pseudorange measurement and φ denotes a carrier-phase measurement. As described in the drawing, the clock synchronization loop filtering unit 407 computes a single differenced range ₘΔₛφ between the master pseudolite 401 and the slave pseudolite 403 based on Equation 9, shown below. In the mean time, since the positions of the clock synchronization loop filtering unit 407 and the pseudolites 401 and 403 are predetermined precisely, the geometrical distance difference ₘΔₛd is determined as Equation 10, shown below. Therefore, the clock synchronization error ₘΔₛb between the master pseudolite 401 and the slave pseudolite 403 is defined as Equation 11.

ₘΔₛφ≡φₘ−φₛ Eq. 9

ₘΔₛd≡dᵣ^{m}−dᵣ^{s} Eq. 10

ₘΔₛb≡bₘ−bₛ=ₘΔₛφ−ₘΔₛd Eq. 11

wherein ₘΔₛφ represents a single differenced range;

φₘ denotes a carrier-phase of the master pseudolite;

φₛ denotes a carrier-phase of the slave pseudolite;

ₘΔₛd denotes a geometrical distance difference between the master pseudolite and the slave pseudolite;

dᵣ^{m} denotes a geometrical distance between the master pseudolite and the reference station;

dᵣ^{s} denotes a geometrical distance between the slave pseudolite and the reference station;

ₘΔₛb denotes a clock synchronization error between the master pseudolite and the slave pseudolite;

bₘ denotes a clock of the master pseudolite; and

bₛ denotes a clock of the slave pseudolite.

The clock synchronization loop filtering unit 407 transmits an operation command Uₖ to the digitally controlled numerical controlled oscillator 405 based on the clock synchronization error of Equation 11.

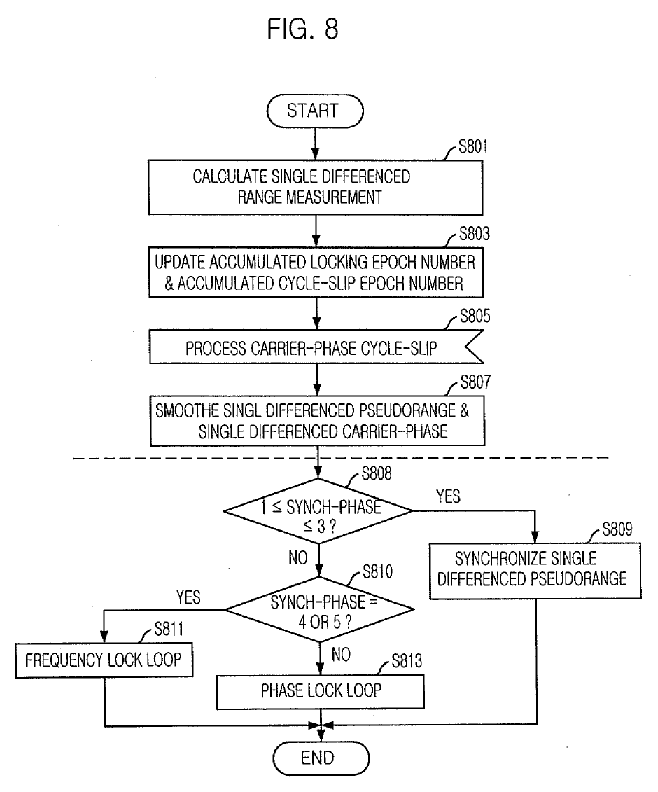

FIG. 8 is a flow chart describing the operation of the clock synchronization loop filtering unit. The clock synchronization loop filtering unit 407 performs the operation of data preconditioning S801 to S807 and pseudolite clock synchronization S809 to S813.

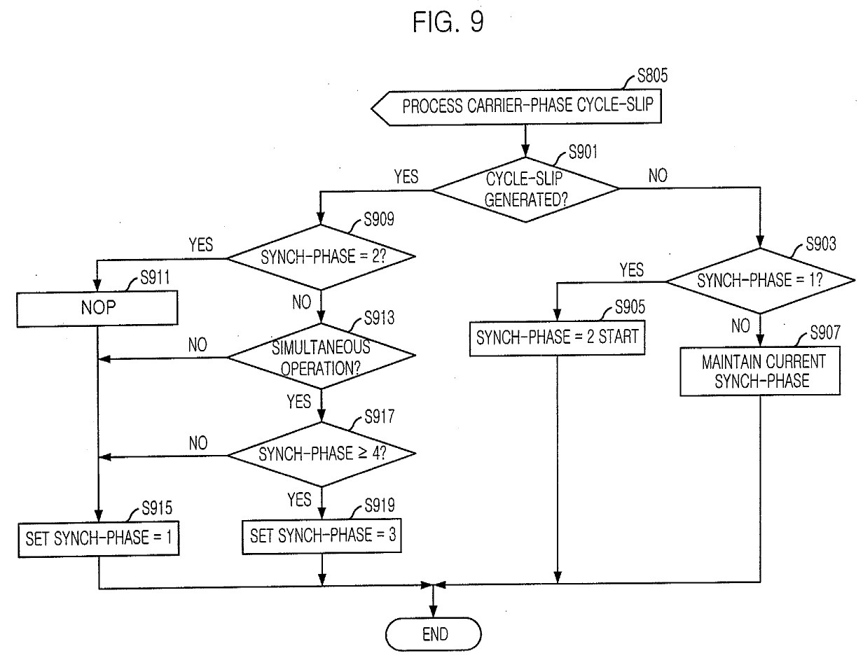

In the data preconditioning process, at step S801, a pseudorange and carrier-phase measurements of all pseudolites are transmitted from a GPS receiver in the clock synchronizations loop filtering unit 407 in a predetermined period (for example, 10 Hz), and then a single differenced measurement between the master pseudolite 401 and the slave pseudolite 403 is calculated. Subsequently, at step S803, an accumulated locking epoch number and an accumulated cycle-slip epoch number are updated. Then, at step S805, a carrier-phase cycle-slip processing is performed as illustrated in FIG. 9, and at step S807, a single differenced pseudorange measurement and a single differenced carrier-phase measurement are smoothed. Here, a single differenced hatch filter and/or a single differenced phi smoothing filter may be used at the step S807. The pseudolite clock synchronization process is performed by using the single differenced pseudorange measurement and the single differenced carrier-phase measurement, which are smoothed through the data preconditioning process.

The pseudolite clock synchronization process includes steps of synchronizing the clocks approximately by using the pseudorange (S809), a frequency lock loop process (S811) using Doppler, and a phase lock loop process (S813) by using a carrier-phase.

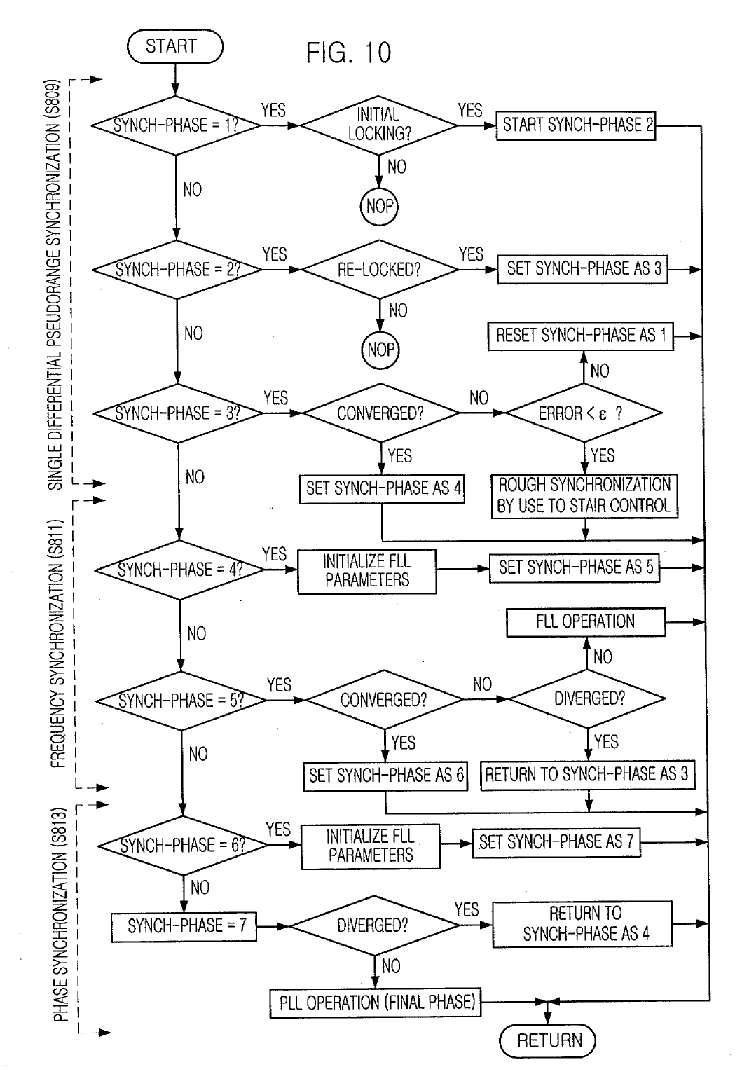

FIG. 10 is a flow chart describing the clock synchronization process conversion order and condition of the clock synchronization loop filtering unit 407. The correspondence of each synch-phase and the clock synchronization process are as shown in the below table.

| | | |
|---|---|---|
| Synch-Phase 1 | Parameter Initialization | Single |
| Synch-Phase 2 | Pseudorange Synchronization | Differenced |
| Synch-Phase 3 | Approximate Synchronization | Pseudorange |
| | of Pseudorange | Synchronization |
| | | (S809) |
| Synch-Phase 4 | Frequency Synchronization | Frequency |
| | Loop Initialization | Synchronization |
| Synch-Phase 5 | Phase Synchronization Loop | (S811) |
| | Initialization | |
| Synch-Phase 6 | Phase Synchronization Loop | Phase |
| | Initialization | Synchronization |
| Synch-Phase 7 | Phase Synchronization | (S813) |

As illustrated in FIGS. 8 and 10, the clock synchronization loop filtering unit 407 performs a process (S809, S811 or S813) in correspondence to the current synch-phase, and updates the synch-phase. Subsequently, it performs the pseudolite clock synchronization process by using the inputted single differenced pseudorange and single differenced carrier-phase measurements, thereby synchronizing the slave pseudolites 403 with the master pseudolite 401 gradually.

In the approximate synchronization process (S809) using the pseudorange, the clock of the slave pseudolite 403 is controlled for a predetermined time Δt (for example, 10 seconds) so that the single differenced pseudorange ₘΔₛρ and geometrical distance ₘΔₛd of the master pseudolite 401 and the slave pseudolites 403 could be agreed.

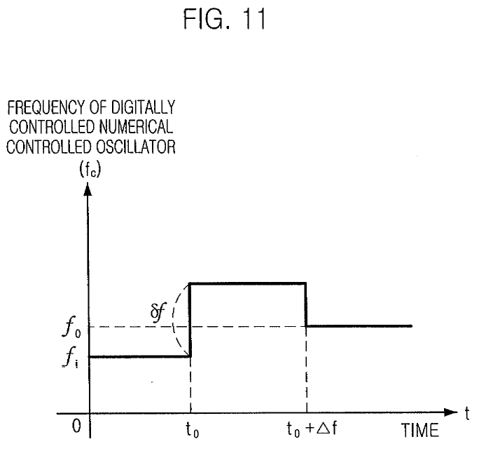

FIG. 11 is a graph illustrating a process of the clock synchronization loop filtering unit 407 controlling a reference clock of the digitally controlled numerical controlled oscillator 405 in the synchronous phase 2 (synch-phase 2). The frequency change amount δf applied to the digitally controlled numerical controlled oscillator 405 of the slave pseudolite 403 at t=t₀ is expressed as Equation 12.

$$δ f = \frac{{}_{m}^{}{Δ}{}_{s}^{} ρ ( {t}_{0} ) - {}_{m}^{}{Δ}{}_{s}^{} d}{Δ t \cdot λ} \qquad Eq . 12$$

Subsequently, a frequency of the digitally controlled numerical controlled oscillator 405 is determined as shown in Equation 13 at t=t₀+Δt to match the Doppler of the slave pseudolite 403 to the Doppler of the master pseudolite.

$${f}_{C} = {f}_{0} = {f}_{i} + \frac{{}_{m}^{}{Δ}{}_{s}^{} \dot{ρ} ( {t}_{0} )}{λ} \qquad Eq . 13$$

wherein fᵢ denotes a clock frequency of the digitally controlled numerical controlled oscillator 405 at t=t₀;

f₀ denotes a clock frequency of the digitally controlled numerical controlled oscillator 405 at t=t₀+Δt; and

ₘΔₛ\dot{ρ}(t₀) denotes a single differenced Doppler measured at t=t₀.

The frequency determined above is transmitted to the digitally controlled numerical controlled oscillator 405 as a synchronization information Uₖ.

Since the reference clock of the slave pseudolite 403 is changed dramatically during the above process, the clock synchronization loop filtering unit 407 cannot track the signal of the slave pseudolite 403 normally. Thus, after the frequency f₀ is supplied to the digitally controlled numerical controlled oscillator 405 of the slave pseudolite 403, the updated Doppler information of the slave pseudolite 403 should be inputted to a channel of the clock synchronization loop filtering unit 407 so as to reduce the signal re-acquisition time.

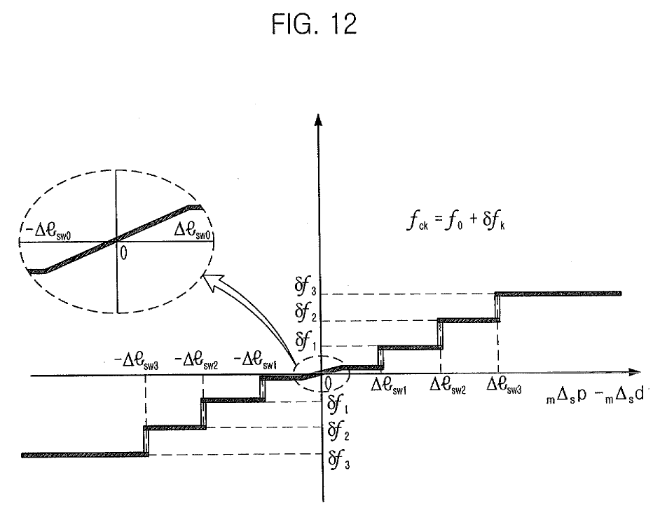

When the clock synchronization loop filtering unit 407 re-acquires the signal, approximate synchronization is performed with respect to the single differenced pseudorange by changing the frequency change amount δfᵢ based on the switching boundary Δρ_{swi}=ₘΔₛρ−ₘΔₛd. The relationship between the switching boundary Δρ_{swi}=ₘΔₛρ−ₘΔₛd and the frequency change amount δfᵢ can be determined in various manners. To take an example, it can be determined experimentally as shown in Table 1 below. FIG. 12 is a graph describing the relationship between the switching boundary and a frequency change amount in the synch-phase 3 of the clock synchronization loop filtering unit 407.

The relationship between the switching boundary Δρ_{swi}=ₘΔₛρ−ₘΔₛd and the frequency change amount δfᵢ is illustrated in FIG. 12.

TABLE 1

| | |
|---|---|
| Δρ_{swi} = ₘΔₛρ − ₘΔₛd (m) | δfᵢ (Hz) |

| | | | |
|---|---|---|---|
| Δρ_{sw1} | 3.0 | δf₁ | 0.005 |
| Δρ_{sw2} | 4.0 | δf₂ | 0.004 |
| Δρ_{sw3} | 5.0 | δf₃ | 0.003 |

When the frequency change amount δfᵢ is switched, it is desirable not to cause chattering by using Schmitt trigger. If the pseudo-synchronization error ₘΔₛρ−ₘΔₛd is not more than 0.5 meter, the approximate synchronization process (S809) using a pseudorange is terminated.

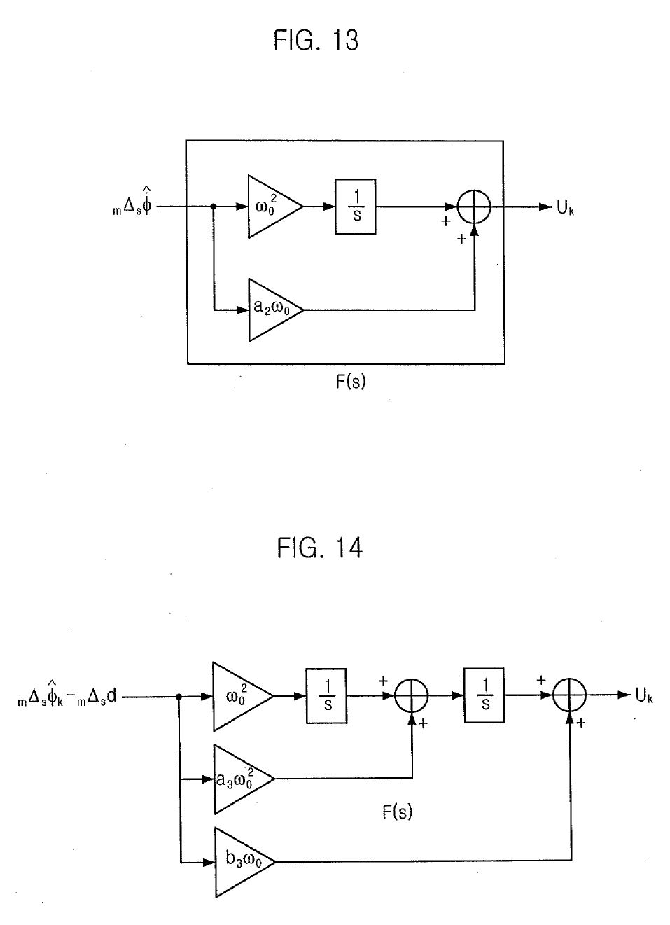

At step S811, frequency synchronization process using Doppler is performed by using the smoothed single differenced Doppler as an input signal and performing discreteness as Equation 14. FIG. 13 is an exemplary schematic diagram showing a secondary frequency synchronization loop filter for frequency synchronization in the synch-phase 5 of the clock synchronization loop filtering unit 407 in accordance with an embodiment of the present invention.

ecₖ=ₘΔₛ{dot over (\hat{φ}ₖ

{dot over (\hat{θ}ₖ₊₁={dot over (\hat{θ}ₖ+T·ω₀²·ecₖ

\hat{θ}ₖ₊₁=\hat{θ}ₖ+T·({dot over (\hat{θ}ₖ+a₂·ω₀·ecₖ)

∴Uₖ={dot over (\hat{θ}ₖ+a₂·ω₀·ecₖ Eq. 14

wherein T=0.1 sec; and {dot over (\hat{θ}₀=f_{C}_{₀}−1.023 MHz.

Meanwhile, ω₀ and a₂ are determined as shown in Equation 15 by the bandwidth Bₙ of the filter.

$${ω}_{0} = \frac{{B}_{n}}{0.53} \\ {a}_{2} = 1.414 {ω}_{0} \qquad Eq . 15$$

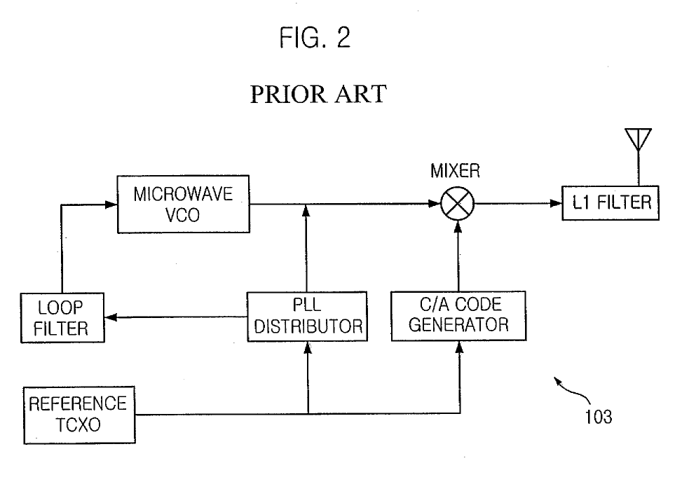

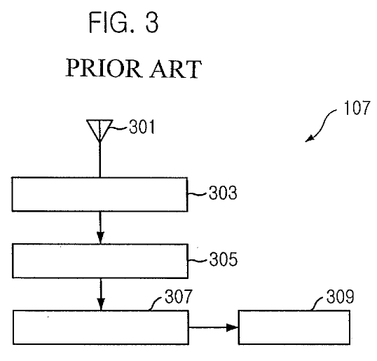

That is, the performance of the frequency synchronization loop filter is wholly determined by the bandwidth Bₙ of the loop filter. Accordingly, the bandwidth Bₙ can be changed gradually based on the size of the single Doppler synchronization error ₘΔₛ{dot over (\hat{φ} without being fixed as one value. The relationship between the size of the single Doppler synchronization error ₘΔₛ{dot over (\hat{φ} and the bandwidth Bₙ can be determined in various manners. For example, it can be determined experimentally as shown in FIG. 2 below.

TABLE 2

| ₘΔₛ\dot{\hat{φ}} (m/s) | Bₙ (Hz) |
|---|---|
| ≦5.0 | 0.20 |
| ≦10.0 | 0.25 |
| ≦20.0 | 0.30 |
| >20.0 | 0.35 |

When the single Doppler synchronization error ₘΔₛ{dot over (\hat{φ} becomes not more than 11.0 m/s, the step S811 is terminated.

At step S813, phase synchronization process using carrier-phase is performed by using the carrier-phase synchronization error ₘΔₛ\hat{φ}−ₘΔₛd as an input signal and performing discreteness as Equation 16. FIG. 14 is an exemplary schematic diagram showing a tertiary phase synchronization loop filter for phase synchronization in the synch-phase 7 of the clock synchronization loop filtering unit 407 in accordance with an embodiment of the present invention.

ecₖ=ₘΔₛ\hat{φ}ₖ−ₘΔₛd

{umlaut over (\hat{θ}ₖ₊₁={umlaut over (\hat{θ}ₖ+T·ω₀³ecₖ

{dot over (\hat{θ}ₖ₊₁={dot over (\hat{θ}ₖ+T·({umlaut over (\hat{θ}ₖ+a₃ω₀²·ecₖ)

{dot over (\hat{θ}ₖ₊₁={dot over (\hat{θ}ₖ+T·({dot over (\hat{θ}ₖ+b₃ω₀·ecₖ)

∴Uₖ={dot over (\hat{θ}ₖ+b₃·ω₀·ecₖ Eq. 16

wherein T=0.1 sec;

{dot over (\hat{θ}₀={dot over (\hat{θ}_{FLL}; and

{umlaut over (\hat{θ}₀={dot over (\hat{θ}_{FLL}

Meanwhile, φ₀, a₃ and b₃ are determined by the bandwidth Bₙ of the filter as shown in Equation 17.

$${ω}_{0} = \frac{{B}_{n}}{0.7845} \\ {a}_{3} = 1.1 \\ {b}_{3} = 2.4 \qquad Eq . 17$$

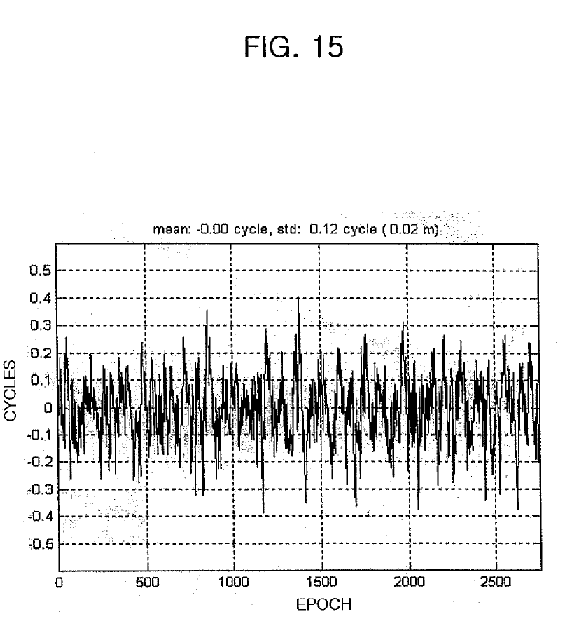

FIG. 15 is a graph illustrating an experimental output of the pseudolite navigation system in accordance with an embodiment of the present invention. After 2500 pieces of data are received, a result that the clocks of the master pseudolite and slave pseudolites are synchronized with an error of standard deviation 0.1 cycle. Since the length of a carrier-phase is around 0.19 m, when the error is converted into a distance, it becomes about 2 cm.

This figure is nothing but an approximate figure obtained in the laboratory. So, it is possible to reduce the carrier-phase error less than 1 cm within the scope of not getting out of the concept of the present invention. This shows that when a three-dimensional mobile station uses carrier-phase, it can detect out its own position within 10 cm, although the result may come out differently according to the arrangement of pseudolites. That is, it can be seen from FIG. 15 that in the precise navigation system using pseudolites of the present invention, the mobile station can position itself by using a GPS receiver only within the error range of 10 cm, without correction information transmitted from an external reference station through a data link.

The system of the present invention can be embodied as a program and stored in a computer-readable recording medium, such as CD-ROM, RAM, ROM, floppy disks, hard disks, optical-magnetic disks and the like.

While the present invention has been described with respect to certain preferred embodiments, it will be apparent to those skilled in the art that various changes and modifications may be made without departing from the scope of the invention as defined in the following claims.

In accordance with the present invention, a mobile station can computes its own position precisely by synchronizing the clocks of pseudolites in a navigation system using pseudolites and, thus, making the clock errors of the pseudolites included in carrier-phase and/or pseudorange, without relying on the correction information transmitted from a reference station.

In accordance with the present invention, since the pseudolite navigation system determines the position of a mobile station by using clock-synchronized pseudolites, it does not require a reference station measuring clock difference information between the pseudolites, i.e., pseudorange and/or carrier-phase correction information. It also does not require a data link between the reference station and the mobile station for transmitting the correction information as well as an additional algorithm for the sampling clock synchronization of the reference station and the mobile station, which is required due to the setup of the data link between the reference station and the mobile station.

We claim:

1. A method for synchronizing a clock of a slave pseudolite with a reference clock of a master pseudolite in a precise navigation system, comprising the steps of:
synchronizing the clock of the slave pseudolite with the reference clock of the master pseudolite based on pseudorange of the master and the slave pseudolites;
performing a frequency synchronization process based on Doppler of the master and the slave pseudolites; and
performing a phase synchronization process based on the carrier-phase of the master and the slave pseudolites.

2. The method as recited in claim 1, further comprising the steps of:
generating a single differenced pseudorange and a single differenced carrier-phase based on pseudorange and carrier-phase of the master and the slave pseudolites; and
smoothing the single differenced pseudorange and the single differenced carrier-phase.

3. The method as recited in claim 1, wherein the step of synchronizing the clock of the slave pseudolite includes the step of performing a synchronization process of the master and slave pseudolites with respect to the single differenced pseudorange by changing the frequency change amount based on the switching boundary.

4. The method as recited in claim 3, wherein the synchronization process of the master and slave pseudolites is terminated if a pseudo-synchronization error is less than 0.5 meter.

5. The method as recited in claim 1, wherein the frequency synchronization process is performed by using a single differenced Doppler, and the phase synchronization process is performed by using a carrier-phase synchronization error.

6. The method as recited in claim 1, wherein the clock of the slave pseudolite is controlled for a predetermined time so that the single differenced pseudorange is matched with a geometrical distance between the master pseudolite and the slave pseudolites.

7. The method as recited in claim 1, where the step of generating a single differenced pseudorange and a single differenced carrier-phase includes the steps of:
computing a single differenced range measurement ₘΔₛφ between the master pseudolite and the slave pseudolite(s) based on Equation 1 below; and
generating a clock synchronization error information ₘΔₛb between the master pseudolite and the slave pseudolite(s) by using Equation 3 based on the single differenced range measurement ₘΔₛsφ between the master pseudolite and the slave pseudolite(s) and geometrical distance difference information ₘΔₛd between the reference station and the master and slave pseudolites, which is predetermined by using Equation 2,
ₘΔₛφ≡φₘ−φₛ Eq. 1
ₘΔₛd≡dᵣ^{m}−dᵣ^{s} Eq. 2
ₘΔₛb≡bₘ−bₛ=ₘΔₛφ−ₘΔₛd Eq. 3
wherein ₘΔₛφ represents a single differenced range;
φₘ denotes a carrier-phase of the master pseudolite;
φₘ denotes a carrier-phase of the slave pseudolite;
ₘΔₛd denotes a single differenced geometrical distance between the master pseudolite and the slave pseudolite;
dᵣ^{m} denotes a geometrical distance between the master pseudolite and the reference station;
dᵣ^{s} denotes a geometrical distance between the slave pseudolite and the reference station;
ₘΔₛb denotes a clock synchronization error between the master pseudolite and the slave pseudolite;
bₘ denotes a clock of the master pseudolite; and
bₛ denotes a clock of the slave pseudolite.

8. The method as recited in claim 1, wherein the frequency synchronization process is performed by changing a bandwidth gradually according to amplitude of a single Doppler synchronization error.

9. The method as recited in claim 1, wherein the frequency synchronization process is terminated if a single Doppler synchronization error becomes less than 1.0 m/s.

10. A method for synchronizing a reference clock of a master slave with a clock of a slave pseudolite in a precise navigation system, comprising the steps of:
performing the clock synchronization process which synchronizes the clock of the slave pseudolite with the clock of the master pseudolite based on the single differenced pseudorange and carrier-phase of the master and slave pseudolites by controlling the clock of the slave pseudolite for a predetermined time so that the single differenced pseudorange is matched with a geometrical distance between the master pseudolite and the slave pseudolites;
performing a frequency synchronization process based on Doppler of the master and slave pseudolites by performing discreteness of a single differenced Doppler; and
performing a phase synchronization process based on the carrier-phase by performing discreteness of the carrier-phase synchronization error,
wherein the clock synchronization process, the frequency synchronization process and the phase synchronization process are sequentially performed.
